(19) United States
(12) Patent Application Publication
(10) Pub. No.: US 2020/0307590 A1
(43) Pub. Date: Oct. 1, 2020

(54) HIGHWAY EXIT DETECTION AND LINE MIRRORING FOR VEHICLE TRAJECTORY DETERMINATION

(71) Applicant: Robert Bosch GmbH, Stuttgart (DE)

(72) Inventors: David Neil VanderLugt, Northville, MI (US); Matthias Alois Erhard Hoelzle, Munich (DE); Ozgur Sen, Stuttgart (DE)

(21) Appl. No.: 16/549,649

(22) Filed: Aug. 23, 2019

Related U.S. Application Data
(60) Provisional application No. 62/826,590, filed on Mar. 29, 2019.

(51) Int. Cl. B60W 30/18; B60W 30/165; B60W 30/09; B60W 30/095; G06K 9/00; G08G 1/16

(52) U.S. Cl. CPC B60W 30/18163; B60W 30/165; B60W 30/09; B60W 30/0956; B60W 2550/408; G08G 1/167; G08G 1/166; B60W 2550/304; G06K 9/00825

(57) ABSTRACT

Systems and methods for determining a planned trajectory of a host vehicle using line mirroring. A plurality of reported lines on a roadway surface are determined based on image data and analyzed to detect a highway exit. When a highway exit is not detected, a planned trajectory for the host vehicle is determined based on a lane defined between two of the reported lines. However, when a highway exit is detected based on an analysis of the reported lines, a planned trajectory of the host vehicle is determined based on a lane defined between one of the reported lines and a mirrored line. The shape of the mirrored line is determined based on the shape of another reported line detected along a first side the host vehicle and is positioned along the other side of the host vehicle opposite the first side.

### RELATED APPLICATIONS

This application claims the benefit of U.S. Provisional Patent Application No. 62/826,590, filed Mar. 29, 2019, the entire contents of which are incorporated herein by reference.

### BACKGROUND

Systems and methods described herein relate to automated driving functions and systems for vehicles. Modern vehicles include various wholly autonomous or partially autonomous driving functions including, for example, adaptive cruise-control, collision avoidance systems, self-parking, and the like.

### SUMMARY

Advanced driver-assistance systems (ADASs) are designed to help reduce driver error and automate, adapt, and/or enhance vehicle systems including, for example, braking systems and cruise control. Some examples of ADASs are forward collision warning (FCW), automatic emergency braking (AEB), and lane keep assist(ance) (LKA).

A LKA system (or other driving system) may be configured to provide autonomous or semi-autonomous driving functions, for example, by steering a vehicle based at least in part on line markings on roadway surfaces. However, line markings are used to mark both continuing lanes and situations where vehicle lanes cross, merge, or diverge—for example, the line markings for an exit lane (or ramp) from a roadway. Accordingly, systems that are configured to steer the vehicle based on line markings may cause a vehicle to erroneously follow line markings associated with, for example, roadway exits when the desired operation is for the vehicle to continue its current trajectory on the roadway. Embodiments described herein provide, among other things, a method and system for detecting the presence of an exit lane and operating a vehicle system based at least in part on detected line marking on the roadway surface for the vehicle's intended trajectory (e.g., continuing to operate in the current lane on the roadway instead of following the exit lane).

One embodiment provides a vehicle trajectory system for a host vehicle including an electronic controller configured to receive image data from at least one camera mounted on the host vehicle. The image data is processed to identify a plurality of reported lines relative to the host vehicle each corresponding to a different actual lane marking on a roadway surface. A highway exit is detected on a second side of the host vehicle based at least in part on an analysis of the plurality of reported lines and a mirrored line is defined along the second side of the host vehicle in response to detecting the highway exit on the second side of the host vehicle. A shape of the mirrored line is defined based at least in part on a shape of a first side reported line detected along a first side of the host vehicle opposite the second side of the host vehicle. When a highway exit is detected on the second side of the host vehicle, a planned trajectory for the host vehicle is determined based on the first-side reported line and the mirrored line. When a highway exit is not detected on the second side of the host vehicle, the planned trajectory for the host vehicle is determined based on the first-side reported line and the second-side reported line.

Other aspects, features, and embodiments will become apparent by consideration of the detailed description and accompanying drawings.

### BRIEF DESCRIPTION OF THE DRAWINGS

FIG. 1 is a block diagram of a host vehicle according to some embodiments.

FIG. 2 is a block diagram of an electronic controller of the system of FIG. 1 according to some embodiments.

FIG. 3 is a schematic diagram of informational components and determinations contributing to a final trajectory determination by the electronic controller of FIG. 2.

FIG. 4 is an overhead view of an example of a vehicle operating on a roadway surface demonstrating a technique for determining a vehicle trajectory by line mirroring.

FIG. 5 is an overhead view of an example of a vehicle operating on a roadway surface demonstrating a technique for line-based exit detection.

FIG. 6 is a flowchart of a method performed by the electronic controller of FIG. 2 for detecting an exit lane using the line-based exit detection of FIG. 5.

FIG. 7 is an overhead view of an example of a vehicle operating on a roadway surface demonstrating a technique for exit detection based on traffic in parallel lanes (TIPL).

FIG. 8 is a flowchart of a method performed by the electronic controller of FIG. 2 for detecting an exit lane using the traffic-in-parallel-lanes (TIPL) technique of FIG. 7.

FIG. 9 is an overhead view of an example of a vehicle operating on a roadway surface demonstrating a technique for exit detection by monitoring a target car.

FIG. 10 is a flowchart of a method performed by the electronic controller of FIG. 2 for detecting an exit lane using the target car technique of FIG. 9.

FIG. 11 is an overhead view of an example of a vehicle operating on a roadway surface demonstrating a technique for exit detection by monitoring three different lines on the roadway surface.

FIG. 12 is a flowchart of a method performed by the electronic controller of FIG. 2 for detecting an exit lane using the three-line technique of FIG. 11.

FIG. 13 is a flowchart of a method performed by the electronic controller of FIG. 2 for using line mirroring to operate the vehicle system using a combination of the four different techniques illustrated in FIGS. 5, 7, 9, and 11 for detecting an exit lane.

FIG. 14 is an overhead view of an example of a vehicle operating on a roadway demonstrating additional conditions that may be detected and monitored by the electronic controller of FIG. 2 in performing the line-based exit detection technique of FIG. 5 in some embodiments.

FIG. 15 is an overhead view of an example of a vehicle operating on a roadway demonstrating additional conditions that may be detected and monitored by the electronic controller of FIG. 2 in performing the TIPL exit detection technique of FIG. 7 in some embodiments.

FIG. 16 is an overhead view of an example of a vehicle operating on a roadway demonstrating additional conditions that may be detected and monitored by the electronic controller of FIG. 2 in performing the target car-based exit detection technique of FIG. 9 in some embodiments.

FIG. 17 is an overhead view of an example of a vehicle operating on a roadway demonstrating additional conditions that may be detected and monitored by the electronic controller of FIG. 2 in performing the three-line-based exit detection technique of FIG. 11 in some embodiments.

FIG. 18 is a flowchart of an alternative method performed by the electronic controller of FIG. 2 for detecting an exit lane and determining an intended vehicle trajectory by line mirroring using the three-line exit detection technique of FIG. 17.

### DETAILED DESCRIPTION

Before any embodiments are explained in detail, it is to be understood that this disclosure is not intended to be limited in its application to the details of construction and the arrangement of components set forth in the following description or illustrated in the following drawings. Embodiments are capable of other configurations and of being practiced or of being carried out in various ways.

A plurality of hardware and software based devices, as well as a plurality of different structural components may be used to implement various embodiments. In addition, embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (for example, stored on non-transitory computer-readable medium) executable by one or more processors. For example, “control units” and “controllers” described in the specification can include one or more electronic processors, one or more memory modules including non-transitory computer-readable medium, one or more input/output interfaces, one or more application specific integrated circuits (ASICs), and various connections (for example, a system bus) connecting the various components.

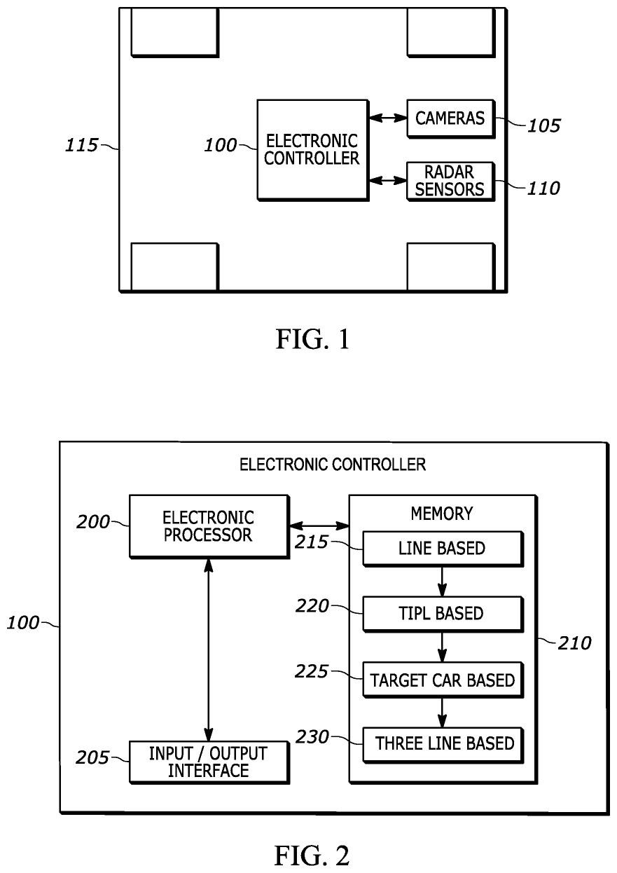

FIG. 1 illustrates a host vehicle 115 with four wheels in block diagram format to illustrate various functional components of the host vehicle 115. The host vehicle 115, although illustrated as a four-wheeled vehicle, may encompass various types and designs of vehicles. For example, the host vehicle 115 may be an automobile, a motorcycle, a truck, a bus, a semi-tractor, and others. In the example illustrated, the host vehicle 115 includes an electronic controller 100. The electronic controller 100 is communicatively coupled to one or more cameras 105 (for example, video cameras). The electronic controller 100 is also communicatively coupled to one or more radar sensors 110.

The electronic controller 100 is communicatively coupled to the cameras 105 and radar sensors 110 via various wired or wireless connections. For example, in some embodiments, the electronic controller 100 is directly coupled via a dedicated wire to each of the above-listed components of the host vehicle 115. In other embodiments, the electronic controller 100 is communicatively coupled to one or more of the components via a shared communication link such as a vehicle communication bus (for example, a controller area network (CAN) bus) or a wireless connection.

Each of the components of the host vehicle 115 may communicate with the electronic controller 100 using various communication protocols. The embodiment illustrated in FIG. 1 provides but one example of the components and connections of the host vehicle 115. However, these components and connections may be constructed in other ways than those illustrated and described herein.

FIG. 2 is a block diagram of the electronic controller 100 of the host vehicle 115. In the example illustrated, the electronic controller 100 includes, among other things, an electronic processor 200 (such as a programmable electronic microprocessor, microcontroller, or similar device), a memory 210 (i.e., non-transitory, computer readable memory), and an input/output interface 205. The electronic processor 200 is communicatively coupled to the memory 210 and the input/output interface 205. The memory 210 stores computer-executable instructions that, when executed by the electronic processor 200, cause the electronic controller 100 to determine a highway exit line as discussed in further detail in the examples below. In this particular example, the memory 210 stores instructions for multiple different techniques for detecting a highway exit lane including a line-based detection software 215, traffic-in-parallel-lanes (TIPL) based detection software 220, target car based detection software 225, and three-line based detection software 230. As described in further detail below, the electronic processor 200 may be configured to run one or more of these different sets of software instructions either concurrently or serially in order to determine whether an exit lane is detected and, in response to determining that an exit lane is likely present, applying a technique such as “lane mirroring” to provide automated or semi-automated guidance functionality for the vehicle. Each software component will be described in greater detail below. In addition, determinations as to when each software component is executed or run will also be described. The electronic processor 200, in coordination with the memory 210, the software 215, 220, 225, and 230 and the input/output interface 205, is configured to implement, among other things, the methods described herein.

The functionality described herein as being performed by the electronic controller 100 may be distributed amongst several electronic computing devices. Additionally, the electronic controller 100 may contain sub-modules that include additional electronic processors, memory, or application specific integrated circuits (ASICs) for handling input/output functions, processing of signals, and application of the methods listed below. In other embodiments, the electronic controller 100 includes additional, fewer, or different components.

In various different embodiments, a vehicle system may be configured to provide automated or semi-automated control for vehicle drive systems (e.g., automated steering, etc.) or navigation systems. Some such systems may be configured to determine a target trajectory for the host vehicle based at least in part on lane marking lines on the surface of the roadway. For example, the lane-keeping assist (LKA) system may be configured to determine a target trajectory where the host vehicle is positioned in a center (or near a center) of a lane in which the host vehicle is operating (e.g., nearly equidistant between the lane marking line on the left side of the vehicle and the lane marking line on the right side of the vehicle). However, in some cases, the lane markings alone may not be sufficient for properly determining whether the vehicle is positioned near a center of the lane. For example, when approaching an exit on a highway, the lane markings may begin to widen until reaching a point where the widened lane is separated into two lanes (e.g, the current operating lane and a highway exit lane) demarcated by a new line marking. However, whether the host vehicle intends to remain in the same operating lane or to take the exit lane to leave the highway, it may be desirable for the lane-keeping assist system to maintain a target trajectory relative to the intended lane of operation instead of maintaining a center position in the widening lane. Accordingly, systems and methods described herein provide mechanisms for, above other things, detecting a highway exit lane and maintaining a target trajectory based on an intended lane of operation.

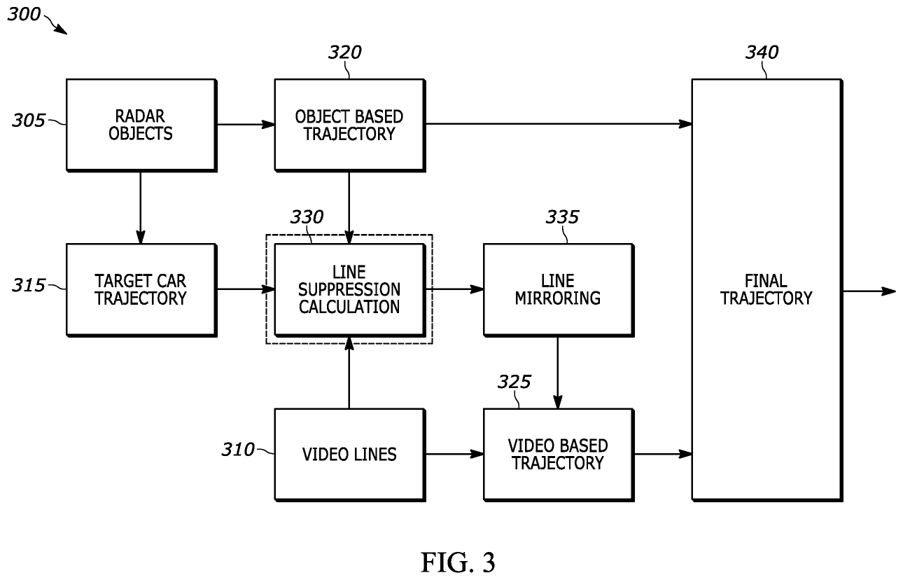

FIG. 3 is a functional block diagram illustrating one example of a system/method 300 that determines a final target trajectory for a host vehicle (for example, the host vehicle 115). In particular, the block diagram 300 references various determinations made by the electronic controller 100 that are, in turn, used to determine the final target trajectory for the host vehicle. First, the electronic controller 100 determines, based at least in part on information from the radar sensors 110, whether any radar object 305 are detectable. The radar objects 305 are objects determined by the electronic controller 100 (or another processor (not shown)) to be present near the host vehicle. The radar objects 305 may include, for example, one or more target cars (for example, a vehicle located directly in front of the host vehicle 115 and vehicles located in lanes adjacent to the host vehicle, for example, to the vehicle's left or right). Based on the location of any detected radar objects 305, the electronic controller 100 determines both an estimated trajectory of other vehicles operating nearby (i.e., target car trajectory 315) and a target trajectory for the host vehicle (i.e., an object based trajectory 320).

The electronic controller 100 also receives image data from the one or more cameras 105 and, based on the received image data, detects the location of highway lines on the road surface. The lines detected on the road surface based on image data are represented in the block diagram 300 as “video lines” 310. The electronic controller 100 uses the video lines to separately determine a target trajectory for the host vehicle based on the image data (referred to in FIG. 3 as the “video based trajectory 325”). In the specific example of FIG. 3, the video-based trajectory 325 is further enhanced by a “line mirroring” technique 335. As noted above, the presence of some line marking on the road surface can negatively affect the determination of a planned trajectory for the host vehicle—for example, a widening of the lane markings due to approaching a highway exit lane. Accordingly, a “line suppression” calculation 330 is applied to avoid using a “wrong line” detected in the image data for the planned trajectory of the host vehicle. Video lines on either the right side of the vehicle or the left side of the vehicle can be suppressed based, for example, on the lines themselves (e.g., jumps, out-of-range values, etc.) or based on a plausibility check with radar based trajectory. Accordingly, the line suppression calculation 330 in the block diagram 300 receives as input the video lines 310, the target car trajectory 315, and the object-based trajectory 320.

After the application of the line suppression calculation, a “line mirroring” technique 335 is applied to replicate complete and proper lane markings on one side of the host vehicle based, for example, on the shaped/appearance of the line on the other side of the host vehicle and previous data regarding lane width, etc. The originally detected video lines 310 and the output of the line suppression 3303 & the line mirroring 335 are used to determine the video-based trajectory 325 for the host vehicle. The object-based trajectory 320 (i.e., a planned trajectory for the host vehicle based on the radar data) and the video-based trajectory 325 (i.e., a planned trajectory for the host vehicle based on the video data) are then used by the electronic controller 100 to determine a final planned trajectory 340 for the host vehicle. This final planned trajectory 340 can be used, for example, by a lane-keeping assist system to automatically steer the vehicle or to provide guidance to the vehicle operator for maintaining a proper lane position as the vehicle moves through the section of the roadway past the highway exit.

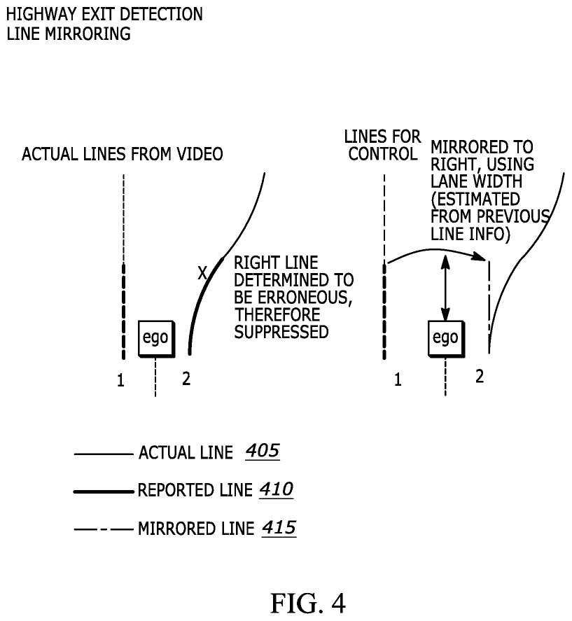

FIG. 4 illustrates an example of the line mirroring process for a host vehicle 115 (also labeled in the drawings as “ego”) and illustrating how actual video lines are replaced with lines for control. In the example provided, the cameras 105 detect actual lines 405 which are the highway lines. As described above in reference to FIG. 3, the images or video of the actual line 405 is provided to the electronic controller 100 and the image data is processed to detect the location of actual lines in the image data. In some implementations, the location of the detected lines (referred to in FIG. 4 as reported lines 410) are determined in 3D space using world coordinates or using coordinates relative to a current location of the host vehicle 115. As discussed above, in reference to FIG. 3, the reported lines 410 (e.g., the “video lines 310”) are used by the electronic controller 100 to determine the video based trajectory 325. However, in some instances, the reported lines 410 are potential highway exit lines and, if followed, a path defined by highway exit lines would cause the video based trajectory 325 to direct the host vehicle 115 to drive off of the highway. As discussed in further detail below, the electornic controller 100 applies one or more different techniques to determine whether the reported line 410 is a proper lane marking line that should be followed in determining a planned trajectory for the host vehicle 115 or whether the reported line 410 is a line that should be suppressed (e.g., a line marking for a highway exit). When a reported line 410 is determined, for example, to be a highway exit line, the reported line 410 is suppressed and replaced with a new virtual line using line mirroring.

In the example of FIG. 4, reported lines 410 are present on both sides of the vehicle 115. The electronic controller 100 determines that the reported line 410 on the left side of the host vehicle 115 is a line that accurately represents the current operating lane, but also determines that the reported line 410 on the right side of the host vehicle 115 is a highway exit line that should not be followed in determining a planned trajectory for the host vehicle 115. Accordingly, the reported line 410 on the right side of the host vehicle 115 is suppressed (i.e., by line suppression calculation 330) and is replaced with a new virtual line that is “mirrored” based on the reported line 410 from the left side of the host vehicle 115. In this example, the electronic controller 100 is configured to generate a “mirrored line” 415 on the right side of the host vehicle 115 that includes the same shape and contour as the reported line 410 on the left side of the host vehicle 115. The location of the newly created mirrored line 415 in 3D space is determined, for example, based on measured characteristics/statistics from previously detected lane marking. For example, the electronic controller 100 may be configured to monitor the average lane width based on a lateral distance between the reported lines 410 on either side of the host vehicle under normal conditions (e.g., when a highway exit is not present) and to place the mirrored line 415 so that the average lane width is maintained between the reported line 410 on the left side of the host vehicle and the mirrored line 415 on the right side of the host vehicle 115. In other implementations, the electronic controller 100 may be configured to adjust the size, shape, and/or position of the mirrored line 415 to align with an upcoming lane marking detected in the image data that will appear on the right side of the host vehicle 115 after the host vehicle has passed the highway exit. Once a position of the mirrored line 415 is determined, the electronic controller 100 will then determine a planned trajectory for the host vehicle 115 based at least in part on the reported line 410 on the left side of the host vehicle 115 and the mirrored line 415 on the right side of the host vehicle 115 (e.g., by determining the target planned trajectory to be along a path that is equidistant between the reported line 410 on the left and the mirrored line 415 on the right).

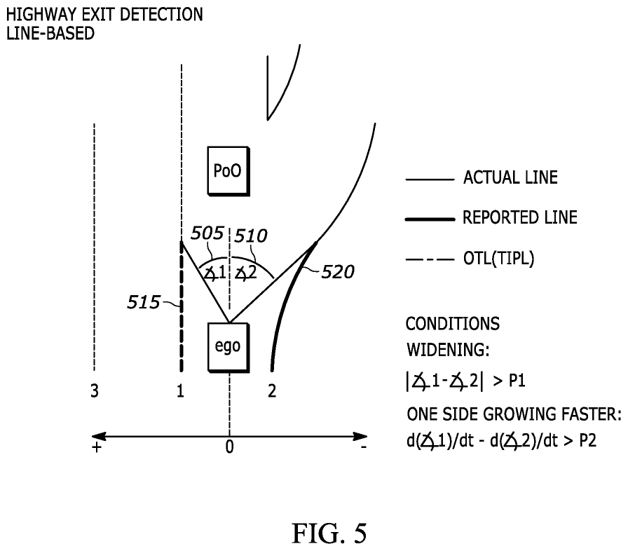

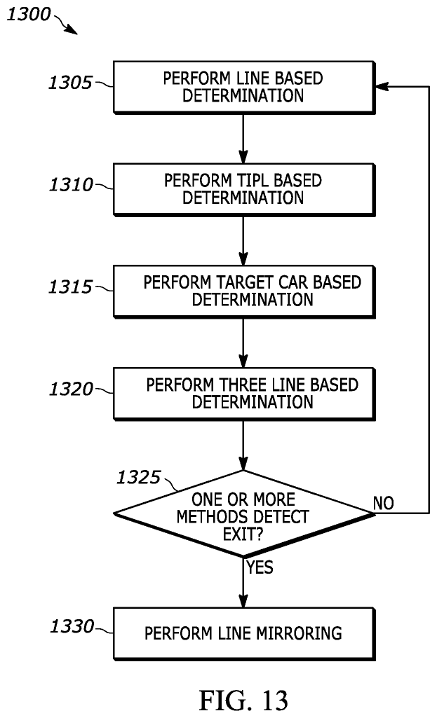

As discussed above, the electronic controller 100 may be configured to apply one or more different techniques for detecting a highway exit and to, in turn, determining whether a reported line 410 on either side of the host vehicle should be suppressed and replaced by a virtual line through line mirroring (as shown in the example of FIG. 4). FIGS. 5 through 12 below illustrate four different highway exit detection mechanisms that determine, based on image data and/or radar data, whether a highway exit has been encountered. The electronic controller 100 may be configured to use one or more of these specific highway detection mechanism alone or in combination to detect a highway exit. For example, as discussed below in FIG. 13, the electronic controller 100 may be configured to apply all four techniques in parallel or serially. Furthermore, in other implementations, other highway exit detection techniques may be used in addition to or instead of the mechanisms illustrates in FIGS. 5 through 12.

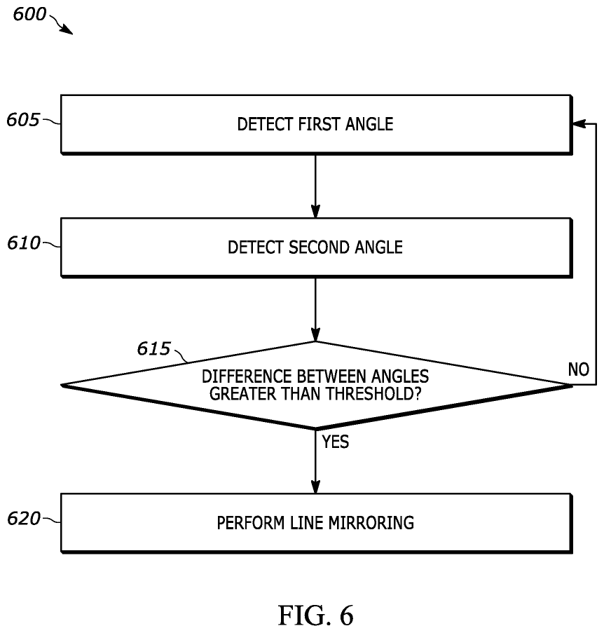

FIGS. 5 and 6 illustrate a mechanism for detecting a highway exit based on lines detected in the image data on either side of the host vehicle. As illustrated in the example of FIG. 5, a left-side reported line 515 is detected on the left side of the host vehicle 115 and a right-side reported line 520 is detected on the right side of the host vehicle 115. However, as the host vehicle 115 approaches the highway exit, the distances between the left-side reported line 515 and the right-side reported line 520 increases. Furthermore, as the host vehicle 115 continues to operate along a trajectory behind a “target vehicle “Pₒ0,” the distance between the host vehicle 115 and the right-side reported line 520 increases more quickly than a distance between the host vehicle 15 and the left-side reported line 515.

FIG. 6 illustrates a method 600 for detecting the highway exit based on these conditions of the two highway lines reported on either side of the host vehicle. First, the electronic controller 100 determines a first angle 505 indicative of an angle between a center line of the host vehicle 115 and a line extending from the host vehicle to a point on the left-side reported line 515 at a defined linear distance in front of the host vehicle 115 (step 605). The electronic controller 100 similarly determines a second angle 510 indicative of an angle between the center line of the host vehicle 115 and a line extending from the host vehicle 115 to a point on the right-side reported line 520 at a defined linear distance in front of the host vehicle 115 (step 610). Examples of the first angle 505 and the second angle 510 are illustrated in FIG. 5.

After the first angle 505 and the second angle 510 are determined based on the image data, the electronic controller 100 determines whether the difference between the angles is greater than a defined threshold (step 615). In some implementations, this determination is made by calculating a difference between the first angle and the second angle 510 and comparing an absolute value of that difference to a defined threshold (e.g., P1 in FIG. 5). In other implementations, the electronic controller 100 may be configured to make this determination based on angle gradients in addition to or instead of based on the absolute value of the difference. For example, the electronic controller 100 may be configured to calculate an angle gradient of the first angle 505 by determining a rate of change of the first angle 505 at step 605 (e.g., by calculating a derivative of the determined first angle 505 over time, or by calculating a difference between the current value of the first angle 505 and a previously calculated value of the first angle 505). Similarly, the electronic controller 100 may be configured to calculate an angle gradient for the second angle 510 at step 610. When using angle gradients, the electronic controller 100 may be configured to determine that an highway exit has been encountered when a difference between the angle gradient for the first angle 505 and the angle gradient for the second angle 510 (or the absolute value of the difference) exceeds a threshold P2.

In response to determining that the width of the lane is increasing, the electronic controller 100 is configured to suppress the reported line corresponding to the angle that is increasing at a greater rate (i.e., the right-side reported line 520 in the example of FIG. 5) and to replace that reported line by line mirroring (step 620).

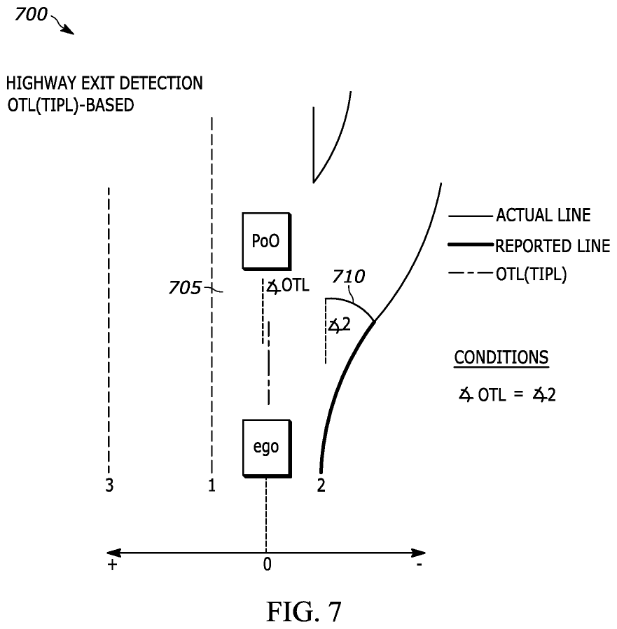

Because the highway exit detection method of FIGS. 5 and 7 is based primarily on the determined location of the reported lines relative to the host vehicle 115, in at least some embodiments, some methods are configured to detect a highway exit based only on image data from the cameras. However, as discussed above in reference to FIG. 3, some exit detection methods are configured to utilize both image data and radar data in detecting a highway exit. In some such examples, the electronic controller 100 may be configured to determine the position of objects (including, for example, nearby vehicles) based on radar data in the same coordinate system that is used to determine the relative location of reported lines from the image data. IN this way, the electronic controller 100 may be configured to compare the position of detected objects (e.g., nearby vehicles) to the position of reported lines in order to determine whether a reported line may be indicative of a highway exit. Furthermore, in some implementations, the electronic controller 100 may be further configured to utilize image data from the camera(s) in addition to or instead of using radar data to determine the relative positioning of objects (e.g., nearby vehicles) in the same coordinate system as the reported lines.

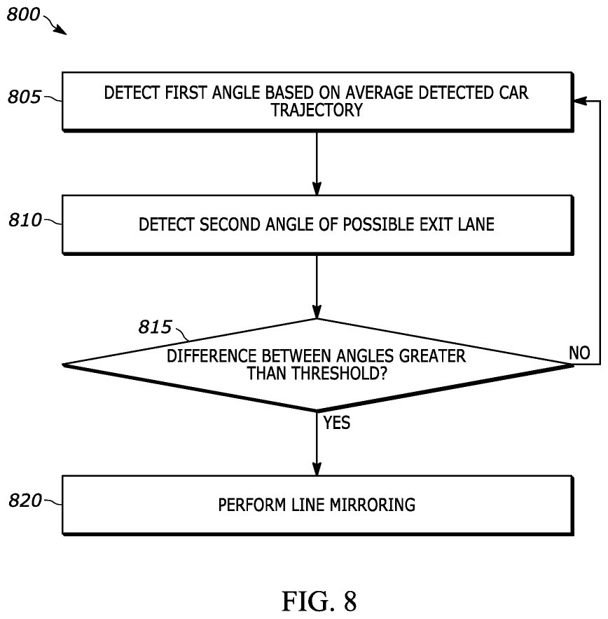

FIGS. 7 and 8 illustrate one example in which the determines position of one or more nearby vehicles relative to the determined position of reported lines is used to detect a highway exit. In particular, the methods illustrated in the example of FIGS. 7 and 8 is configured to detect a highway exit based on traffic in parallel lanes (referred to herein as a “TIPL” (traffic-in-parallel-lanes) method). As discussed above in reference to FIG. 3, in some implementations, the electronic controller 100 is configured to detect the presence of other nearby vehicles and to determine the trajectory of those nearby vehicles (i.e., the “target car trajectory”). In the example of FIGS. 7 and 8, a highway exit lane is detected based on the determined “target car trajectory” for one or more nearby vehicle.

In the method 800 of FIG. 8, the electronic controller 100 determines an angle 705 based on the an average target car trajectory (step 805). For example, the angle 705 may be calculated based on an average angle of one or more target car trajectories relative to a current trajectory of the host vehicle, relative to a center line of the host vehicle 115, or relative to one of the two reported lines (e.g., line 1 in FIG. 7). The electronic control 100 also determines an angle 710 indicative of an angle of a possible exit lane (step 810). For example, the angle 710 may be calculated based on a calculated angle of a reported line (e.g., the right-side reported line 2 in the example of FIG. 7) and a center line of the host vehicle 115. Alternatively, in some implementations, the electronic controller may be configured to calculate the angle 710 by applying a preliminary lane mirroring technique to create a mirrored line and then calculating an angle between the mirrored line and the reported line on the same side of the host vehicle. Because lane marking lines may not always be straight, the angles based on a possible exit lane may be determined in at least some implementations, for example, by performing a “best fit” calculation to determine a straight line that most closely fits a shape of the reported line or by identifying a line that is tangential to the reported line.

After the angle 705 and the angle 710 are both calculated, the electronic controller 100 compares the angle 705 and the angle 710 (step 815). If there is no highway exit, then the trajectory of the target vehicle(s) should generally run parallel to the reported line. Therefore, if the angle 705 indicative of the average target car trajectory is not equal to the angle 710 indicative of the angle of the possible highway exit line, then the electronic controller 10 determines that a high way exit has been encountered and applies line mirroring to replace the line that has been determined to indicate the highway exit (i.e., the line with the angle that deviates from the average target car trajectory) (step 820). In some implementations, the electronic controller 100 is configured to determine that a highway exit has been encountered only when the difference between the angle 705 and the angle 710 exceeds tolerance threshold to allow for naturally occurring variation in the actual driving trajectory of the target vehicles.

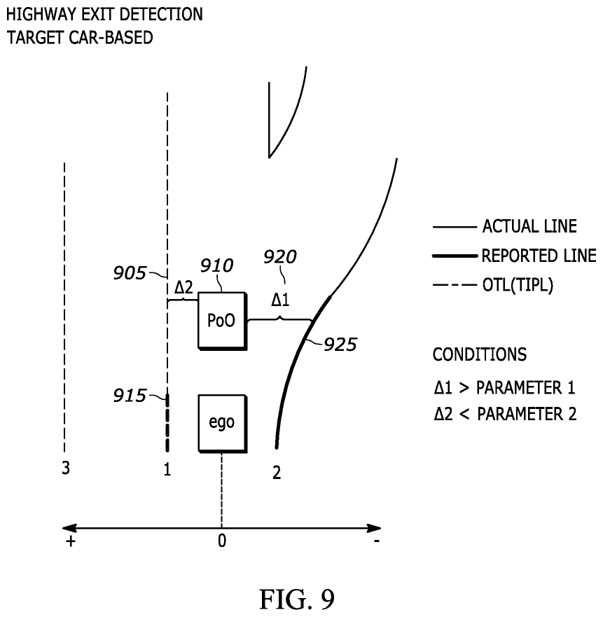

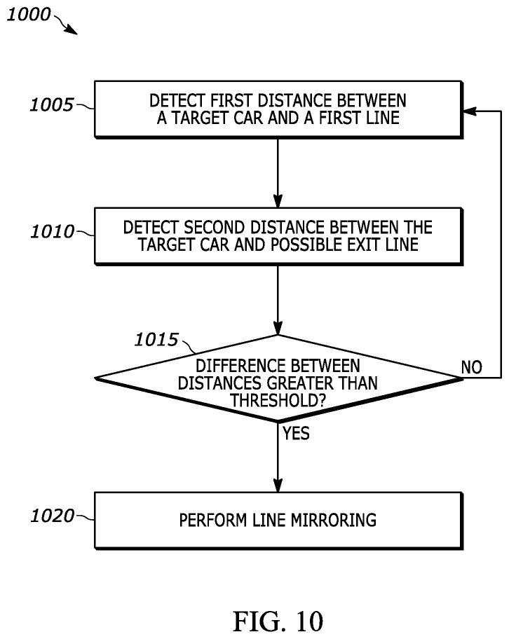

FIGS. 9 and 10 illustrate another example of an exit detection method based on the detection of one or more target cars operating nearby the host vehicle 115. While the example of FIGS. 7 and 8 compares angles based on the target car trajectory of other nearby vehicles relative to the reported lines, the method of FIGS. 9 and 10 more specifically focuses on measuring distances between one or more target cars and the reported lines from the image data. In the example of FIG. 9, another vehicle (target vehicle 910) is operated in the same lane as the host vehicle 115 directly in front of the host vehicle 115. As the host vehicle 115 and the target vehicle 910 both approach the lane exit, the lateral distance 905 between the target vehicle 910 and a left-side reported line 915 remains substantially constant. However, the lateral distance 920 between the target vehicle 910 and a right-side reported line 915 will increase as the target vehicle 910 approaches the highway exit.

According to the method 1000 of FIG. 10, the electronic controller 100 first determines a first distance 905 between a detected target car 910 and one of the two reported lines on either side of the target car 910 (step 1005). The electronic controller 100 then determines a second distance 920 between the detected target car 910 and the reported line on the opposite side of the target car (step 1010). If a difference between these two distances is greater than a defined threshold (step 1015), then the electronic controller 100 determines that a highway exit has been encountered and performs lane mirroring to determine a planned trajectory of the host vehicle 115.

In some implementations, the electronic controller 100 may be configured to determine a difference between the raw measured distances 905, 920 at a particular time. However, in other implementations, the electronic controller 100 may be configured to calculate distance gradients (e.g., rates of change of the measured distances) in addition to or instead of the comparison of the raw distance values in determining whether a highway exit has been encountered. For example, the electronic controller 100 may be configured to determine a rate of change of the first distance 905 and a rate of change of the second distance 920 based on the current determined distances and a previous set of determined distances at a previous time. By comparing the rate of change of the first distance 905 to the rate of change of the second distance 920, the electronic controller 100 is able to determine whether one distances is increasing at a greater rate than the other, which is indicative of a lane widening to one side of the target vehicle 910. Furthermore, the electronic controller 100 may be configured to identify the reported line corresponding to the distance that is increasing at the greater rate as the reported line that is indicative of the highway exit and, accordingly, the reported line that will then be suppressed and replaced with a mirrored line in order to determine a planned trajectory for the host vehicle 115.

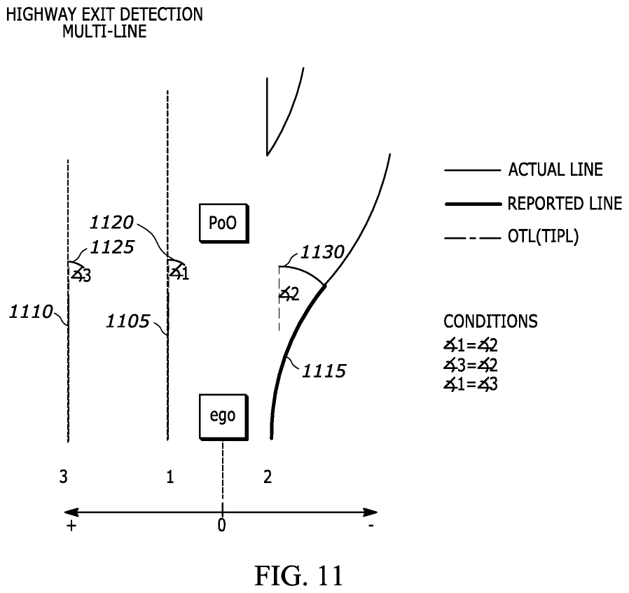

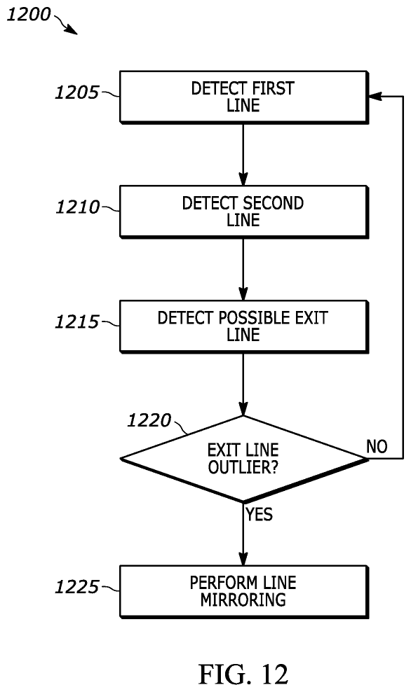

Although the examples describe above primarily focus on detecting only a single pair of reported lines from the image data, in some implementations, methods for detecting a highway exit may be configured to detect additional lines indicative of other lanes marked on the same roadway surface. FIGS. 11 and 12 illustrate one such example in which a highway exit is detected based on three reported lines. However, the method of FIGS. 11 and 12 can be further extended to situations where four or more lines are detected in the image data and used to detect a highway exit.

In the example situation of FIG. 11, three different lines on the highway surface are detected by the electronic controller 100 based on the image data. A left-side reported line 1105 is detected defining the left-side of a lane currently occupied by the host vehicle 115. A right-side reported line 1130 is detected defining the right-side of the lane currently occupied by the host vehicle 115. And left-side adjacent lane reported line 1110 is detected defining a left-side of an additional lane to the left side of the host vehicle 115. Accordingly, the left-side reported line 1105 is positioned between the host vehicle 115 and the left-side adjacent lane reported line 1110. As illustrated in the example of FIG. 11, reported lines that are indicative of continuous, ongoing lanes are generally expected to follow the same shape and to be parallel to each other. However, a line that is instead indicative of a highway exit (i.e., right-side reported line 1115) will deviate from the shape and position of the other lines.

In the method 1200 of FIG. 12, the electronic controller 100 is configured to detect a highway exit based on a comparison of “angles” indicative of each of the three (or more) reported lines. The electronic controller 100 calculates a first angle indicative of a first line (step 1205), calculates a second angle indicative of a second reported line (step 1210), and calculates a third angle indicative of a third reported line (step 1215). If one of the three calculated angles is an outlier (e.g., differing from the other calculated angles by more than a defined tolerance) (Step 1220), the electronic controller 100 identifies the line corresponding to the outlier angle as corresponding to a highway exit. The electronic controller 100 will then use lane mirroring to suppress and replace the identified line with a mirrored line, which is then in turn used to determine a planned trajectory for the host vehicle 115.

The specific mechanism for calculating each angle can vary as long as the same frame of reference is used to calculate all three of the angles. For example, all three angles can be calculated relative to a center line of the host vehicle 115. Alternatively, one of the reported lines can be defined as the base line and the angles of the other lines can be determined relative to the “base line.” As discussed above in reference to the example of FIGS. 7 and 8, because lane marking lines on the roadway surface might not always be straight (e.g., they can be curved), the “angle” of a line can, in some implementations, be calculated by determining a “best fit” straight line for a reported line or by determining a straight line that is tangential to the reported line.

In the example of FIG. 11, angle 1120 is defined as the angle of the left-side reported line 1105, angle 1125 is the angle of the left-side adjacent lane reported line 1110, and angle 1130 is the angle of the right-side reported line 1115. Accordingly, the electronic controller 100 may be configured to determine the angle 1125 as the angle of the left-side adjacent lane reporting line 1110 relative to the left-side reported line 1105 and to determine the angle 1130 as the angle of the right-side reported line 1115 relative to the left-side reported line 1105. In this case, the angle 1120 would be defined as 0° (i.e., the angle of the left-side reported line 1105 relative to itself). The electronic controller 100 could then detect a highway exit based on comparison of these angles. Because the angle of the left-side adjacent lane reported line 1110 is equal to 0° (i.e., parallel to the left-side reported line 1105), the electronic controller 100 determines that there is no highway exit on the left side of the road. However, because the angle of the right-side reported line 1115 is not equal to 0° (i.e., is not parallel to the left-side reported line 1105), the electronic controller 100 concludes that a highway exit has been encountered on the right side of the host vehicle 115.

As discussed above, one or more highway exit detections mechanism can be applied by the electronic controller 100 in parallel or in series in order to determine whether a highway exit is encountered. FIG. 13 illustrates an example of a method 1300 applying a combination-based exit detection. In the method 1300, the electornic controller performs the line-based determination of FIGS. 5 and 6 (step 1305), the TIPL-based determination of FIGS. 7 and 8 (step 1310), the target car distance-based determination of FIGS. 9 and 10 (step 1315), and the multiple-lines-based determination of FIGS. 11 and 12 (step 1320). In some implementations, the electronic controller 100 may be configured to perform these four separate determinations in parallel or to subsequently move from one determination to another in serial fashion such that a subsequent determination is only calculated depending on the output of the previous determination. In still other implementations, the calculations and steps outlined for the various different determinations can be combined in a sequence that is better optimized to complete all of the separate determinations.

In the example of FIG. 13, it one or more of the determination methods indicates that an highway exit has been encountered (step 1325), then the electronic controller performs the line suppression and line mirroring (step 1330) before using the newly created “mirrored line” for determining a planned trajectory of the host vehicle. In other implementations, the electronic controller 100 will conclude that a highway exit has been encountered only when all four of the determination methods indicate that a highway exit has been detected. In still other implementations, the sensitivity of the overall highway exit detection can be adjusted by correspondingly adjusting the number of “positive” determinations that are required in order for the electronic controller 100 to perform the line mirroring (e.g., 1 of 4, 2 of 4, 3 of 4, or 4 of 4).

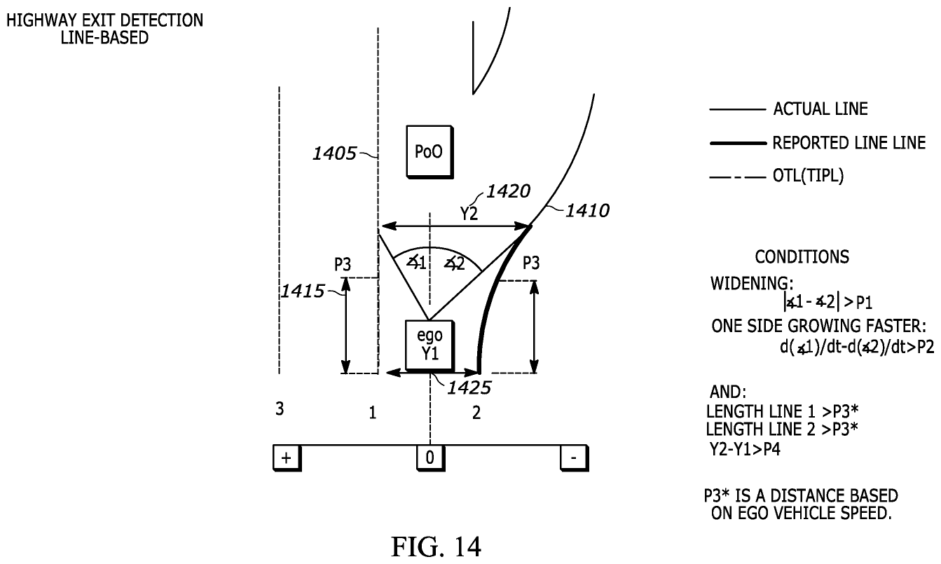

Also, as noted above, in some implementations, more, fewer, or different determination techniques may be implemented by the electronic controller 100 in order to determine when to apply the line suppression and line mirroring techniques for determining a planned trajectory of the host vehicle 115. Similarly, the methods illustrated in the foregoing examples can be further modified, for example, by combining certain metrics into a single determination or by adjusting the thresholds or conditions associated with each determination. For example, in some embodiments, cameras 105 may not obtain enough information such as a threshold level of information for an accurate determination and, therefore, additional information from the radar sensors 110 might be utilized to assist in determining whether a highway exit has been encountered. Similarly, in some embodiments, radar sensors 110 may not obtain enough information for an accurate determination and may, therefore, be supplemented by information from the cameras 105. FIGS. 14 through 17 illustrates some examples of variations on these methods for detecting a highway exit based at least in part on line markings identified in captured image data.

FIG. 14 illustrates example conditions for the line based exit detection method 600. In some embodiments, determinations made by the method 600 may be inaccurate unless the cameras 105 obtain information sufficient to make an estimation of the existence of a highway exit line. For example, in some instances, it is preferable that information about a first line 1405 and a second line 1410 is greater than a threshold amount of line or detected length (for example, threshold amount 1415). The threshold amount of line may be a predetermined threshold. The amount of line may be determined based at least in part on the speed of the host vehicle 115. Additionally, the line based exit detection method 600 may be inaccurate unless a difference between the first line 1405 and second line 1410 is greater than a threshold amount. FIG. 14 shows two example distance between the first line 1405 and the second line 1410, namely a first detected distance 1420 and a second detected distance 1425. Therefore, the line based exit detection method 600 may be inaccurate unless a threshold amount of a first line 1405 and a second line 1410 are detected (for example, more than 30 feet in some embodiments) and further where a distance between the first line 1405 and second line 1410 is greater than a threshold amount (for example, more than 1 foot in some embodiments). Additionally, as noted with respect to the description of FIG. 5, in some embodiments, line based detection begins after a precondition (for example, detection of a threshold difference in distance) occurs. The precondition may be, for example, the difference between first detected distance 1420 (Y2) and a second detected distance 1425 (Y1).

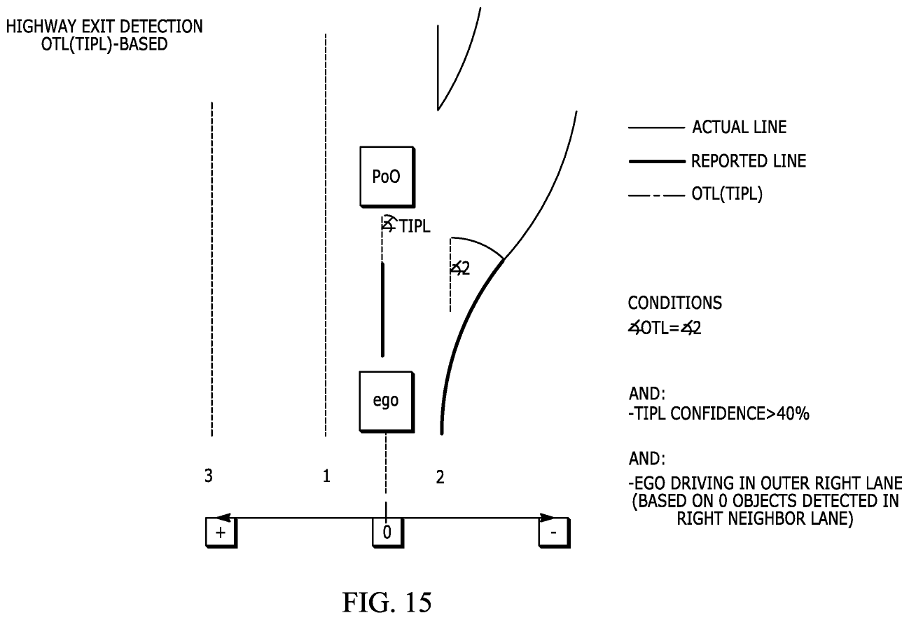

FIG. 15 illustrates conditions for the TIPL based exit detection method 800. In some embodiments, determinations made by the method 800 may be inaccurate unless the radar sensors 110 obtain information sufficient to make an estimation of the existence of a highway exit line. For example, in some instances, sufficient information may be a TIPL confidence level that is greater than a threshold level (for example 40%) and that the host vehicle 115 is detected to be driving in an outer right lane. The TIPL confidence level is a confidence that the radar sensors 110 are accurately detecting traffic in parallel lanes to the host vehicle 115. In one example, the TIPL confidence level is based on how well a single radar object aligns with a polynomial using current data and past history points as well as the total number of objects used to make each lane. A determination that the host vehicle 115 is driving in an outer right lane may be based on zero detected objects in a right side to the host vehicle 115. Therefore, the TIPL based exit detection method 800 may be inaccurate unless a TIPL confidence level is greater than a threshold and the host vehicle 115 is detected to be driving in an outer right lane.

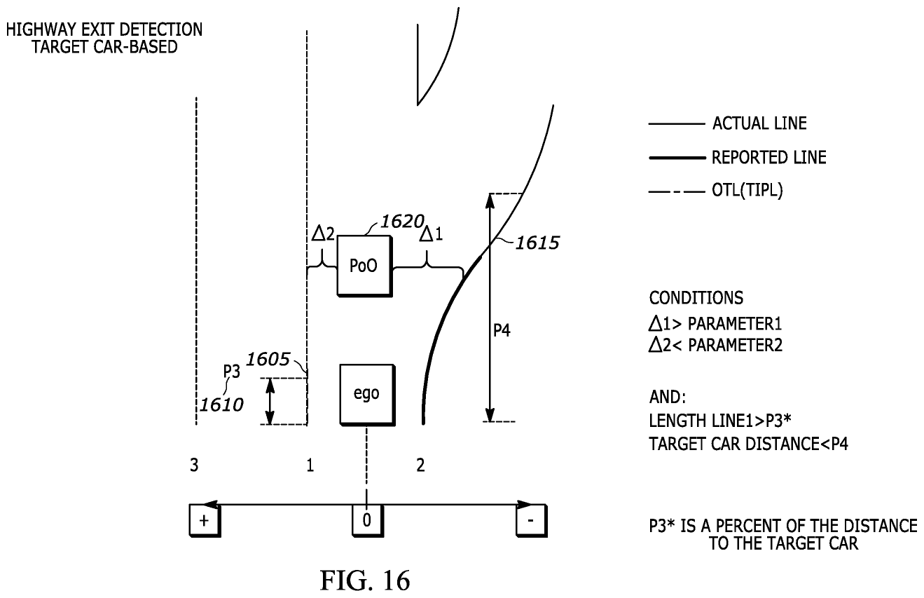

FIG. 16 illustrates conditions for the operation of the target car based exit detection method 1000. In some embodiments, determinations made by the method 1000 may be inaccurate unless the cameras 105 obtain information sufficient to make an estimation of the existence of a highway exit line. For example, in some instances, it is preferred that a first line length 1605 detected by cameras 105 is greater than a threshold amount 1610. In some embodiments, this threshold amount 1610 is not a set amount. Rather, this threshold amount 1610 is a set percentage of the distance between the host car and the target car 1620. The distance of line length 1605 detected by the cameras 105 may be determined based at least in part on the speed of the host vehicle 115. Additionally, in some instances a distance between the host vehicle 115 and a target car 1620 is preferably less than a threshold amount 1615. Therefore, the target car based exit detection method 1000 may be inaccurate unless a first line 1605 is greater than a threshold and a distance between the host vehicle 115 and a target car 1620 is less than a threshold distance 1615.

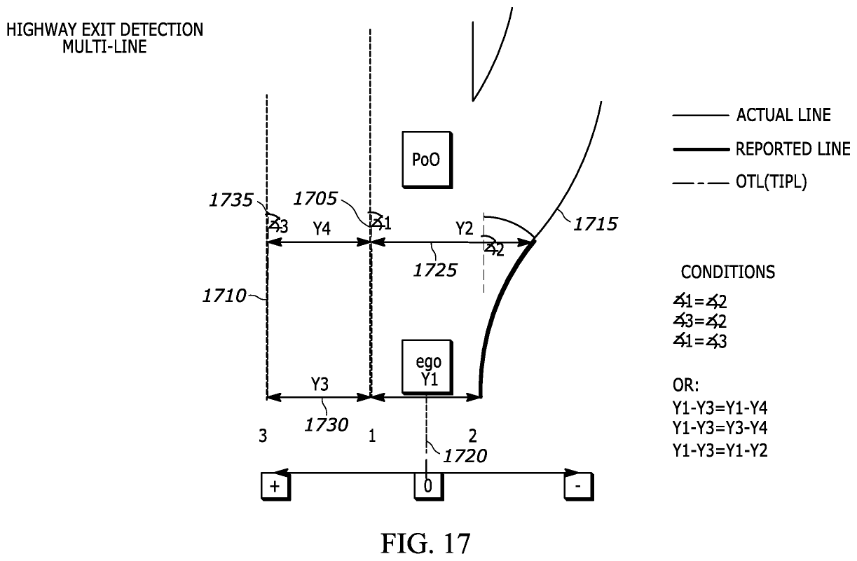

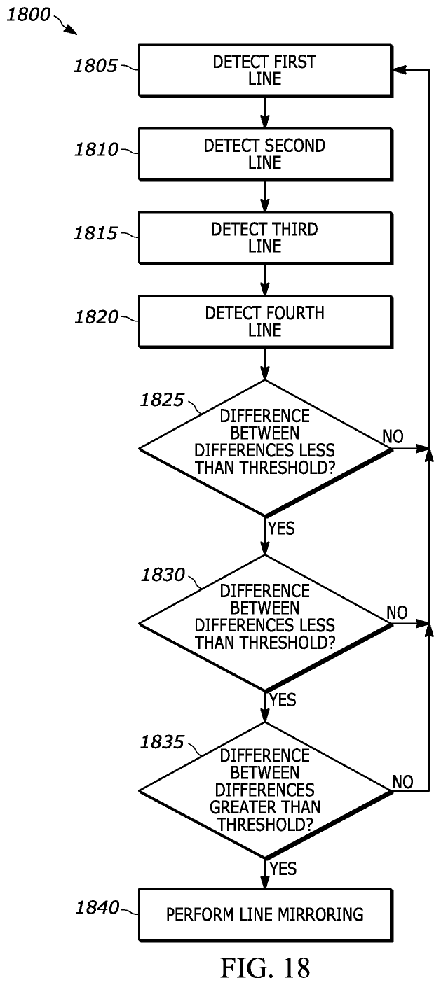

FIG. 17 illustrates an alternative embodiment of the three line highway exit detection determination. In this alternative embodiment, a first line 1705 is detected, a second line 1710 is detected, and a third line 1715 which is a potential highway exit line is detected. The alternative embodiment of FIG. 17 is also illustrated in the flowchart shown in FIG. 18. Conditions that help improve accuracy of the three line based exit detection of FIG. 12 and the alternative embodiment of the three line based exit detection of FIG. 18 include, for example, detection of at least a threshold amount of a first line 1705, a second line 1710, and a third line 1715. If the cameras 105 cannot detect at least a threshold distance of line for each of these three line segments (where the threshold distance is determined at least in part based on the speed of the host vehicle 115) then accuracy of the three line based highway exit detection method of FIG. 12 and FIG. 18 may be reduced.

FIG. 18 is a flowchart of a method 1800 for an alternative embodiment of the three line highway exit detection determination. In step 1805, a first distance 1720 is detected between the third line 1715 and the first line 1705. In step 1810, a second distance 1725 is detected between the third line 1715 and the first line 1705. In step 1815, a third distance 1730 is detected between the first line 1705 and the second line 1710. In step 1820, a fourth distance 1735 is detected between the first line 1705 and the second line 1710. In step 1825, the difference between the first distance 1720 and the third distance 1730 is compared to the difference between the first distance 1720 and the fourth distance 1735. If the difference between these two differences is less than a threshold value, the method proceeds to step 1830. If the difference between these two differences is greater than the threshold value the method begins determining a first distance 1720 in step 1805. In step 1830, the difference between the first distance 1720 and the third distance 1730 is compared to the difference between the third distance 1730 and the fourth distance 1735. If the difference between these two differences is less than a threshold value, the method proceeds to step 1835. If the difference between these two differences is greater than the threshold value the method begins determining a first distance 1720 in step 1805. In step 1835, the difference between the first distance 1720 and the third distance 1730 is compared to the difference between the first distance 1720 and the second distance 1725. If the difference is greater than a threshold value the method proceeds to step 1840, where line mirroring is performed. If the difference between these two differences is less than a threshold value the method begins determining a first distance 1720 in step 1805.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Various features, advantages, and embodiments are set forth in the following claims.

1. A vehicle trajectory system for a host vehicle, the system comprising an electronic controller configured to:
receive image data from at least one camera mounted on the host vehicle, wherein a field of view of the image data include an operating lane currently occupied by the host vehicle,
identify from the image data locations of a plurality of reported lines relative to the host vehicle, wherein each reported line of the plurality of reported lines corresponds to a different actual lane marking line of a plurality of actual lane marking lines on a roadway surface, wherein the plurality of reported lines includes a first-side reported line along a first side of the host vehicle and a second-side reported line along a second side of the host vehicle, the second side being opposite the first side,
detect a highway exit on the second side of the host vehicle based at least in part on an analysis of the plurality of reported lines;
define a mirrored line along the second side of the host vehicle in response to detecting a the highway exit on the second side of the host vehicle, wherein a shape of the mirrored line is determined based at least in part on a shape of the first-side reported line;
determine a planned trajectory for the host vehicle based on a lane defined by the first-side reported line and the mirrored line when a highway exit is detected on the second side of the host vehicle; and
determine the planned trajectory for the host vehicle based on a lane defined by the first-side reported line and the second-side reported line when a highway exit is not detected on the second side of the host vehicle.

2. The vehicle trajectory system of claim 1, wherein the electronic controller is further configured to determine a target lane width based on a previously detected distance between the first-side reported line and a second-side reported line, and wherein the electronic controller is configured to define the mirrored line by duplicating the shape of the first-side reported line and positioning the duplicated shape along the second side of the host vehicle positioned at a distance from the first-side reported line equal to the target lane width.

3. The vehicle trajectory system of claim 1, wherein the first side of the host vehicle is a left side of the host vehicle and the second side of the host vehicle is a right side of the host vehicle.

4. The vehicle trajectory system of claim 1, wherein the first side of the host vehicle is a right side of the host vehicle and the second side of the host vehicle is a left side of the host vehicle.

5. The vehicle trajectory system of claim 1, wherein the electronic controller is configured to detect the highway exit on the second side of the host vehicle based at least in part on the analysis of the plurality of reported lines by:
determining a first value indicative of a distance between the host vehicle and the first-side reported line;
determining a second value indicative of a distance between the host vehicle and the second-side reported line; and
detecting the highway exit on the second side of the host vehicle in response to determining that the distance between the host vehicle and the second-side reported line is increasing at a greater rate than the distance between the host vehicle and the first-side reported line.

6. The vehicle trajectory system of claim 1, wherein the electronic controller is configured to detect the highway exit on the second side of the host vehicle based at least in part on the analysis of the plurality of reported lines by:
identifying a location of a target vehicle operating on the roadway surface based on radar data received by the electronic controller from at least one radar sensor;
determining a first angle indicative of trajectory of the target vehicle;
determining a second angle indicative of the second-side reported line; and
detecting the highway exit on the second side of the host vehicle in response to determining that a difference between the first angle and the second angle exceeds a defined tolerance threshold.

7. The vehicle trajectory system of claim 6, wherein the first angle is indicative of an angle of the trajectory of the target vehicle relative to a current trajectory of the host vehicle, and wherein the second angle is indicative of an angle of the second-side reported line relative to the current trajectory of the host vehicle.

8. The vehicle trajectory system of claim 1, wherein the electronic controller is configured to detect the highway exit on the second side of the host vehicle based at least in part on the analysis of the plurality of reported lines by:
identifying a location of a target vehicle operating on the roadway surface;
determining a first value indicative of a lateral distance between the target vehicle and the first-side reported line;
determining a second value indicative of a lateral distance between the target vehicle and the second-side reported line; and
detecting the highway exit on the second side of the host vehicle in response to determining that the second value is increasing at a greater rate than the first value.

9. The vehicle trajectory system of claim 1, wherein the electronic controller is configured to detect the highway exit on the second side of the host vehicle based at least in part on the analysis of the plurality of reported lines by:
determining, for each reported line of the plurality of reported lines, an angle of the reported line relative to a same reference line; and
detecting the highway exit on the second side of the host vehicle in response to determining that the angle of the second-side reported line deviates from the angle for each of the other reported lines relative to the same reference line.

10. The vehicle trajectory system of claim 1, wherein the electronic controller is further configured to apply a plurality of different exit detection methods based on the plurality of reported lines, and wherein the electronic controller is configured to detect the highway exit on the second side of the host vehicle based on output from each of the plurality of different exit detection methods.

11. A method for determining a planned trajectory of a host vehicle, the method comprising:
receiving, by an electronic controller, image data from at least one camera mounted on the host vehicle, wherein a field of view of the image data include an operating lane currently occupied by the host vehicle,
identifying, by the electronic controller, from the image data locations of a plurality of reported lines relative to the host vehicle, wherein each reported line of the plurality of reported lines corresponds to a different actual lane marking line of a plurality of actual lane marking lines on a roadway surface, wherein the plurality of reported lines includes a first-side reported line along a first side of the host vehicle and a second-side reported line along a second side of the host vehicle, the second side being opposite the first side,
detecting, by the electronic controller, a highway exit on the second side of the host vehicle based at least in part on an analysis of the plurality of reported lines;
defining, by the electronic controller, a mirrored line along the second side of the host vehicle in response to detecting a the highway exit on the second side of the host vehicle, wherein a shape of the mirrored line is determined based at least in part on a shape of the first-side reported line;
determining, by the electronic controller, the planned trajectory for the host vehicle based on a lane defined by the first-side reported line and the mirrored line when a highway exit is detected on the second side of the host vehicle;
determining, by the electronic controller, the planned trajectory for the host vehicle based on a lane defined by the first-side reported line and the second-side reported line when a highway exit is not detected on the second side of the host vehicle; and
operating at least one system of the host vehicle based at least in part on the planned trajectory for the host vehicle.

12. The method of claim 11, further comprising determining a target lane width based on a previously detected distance between the first-side reported line and a second-side reported line, and wherein defining the mirrored line includes duplicating the shape of the first-side reported line and positioning the duplicated shape along the second side of the host vehicle positioned at a distance from the first-side reported line equal to the target lane width.

13. The method of claim 11, wherein the first side of the host vehicle is a left side of the host vehicle and the second side of the host vehicle is a right side of the host vehicle.

14. The method of claim 11, wherein the first side of the host vehicle is a right side of the host vehicle and the second side of the host vehicle is a left side of the host vehicle.

15. The method of claim 11, wherein detecting the highway exit on the second side of the host vehicle based at least in part on the analysis of the plurality of reported lines includes:
determining a first value indicative of a distance between the host vehicle and the first-side reported line;
determining a second value indicative of a distance between the host vehicle and the second-side reported line; and
detecting the highway exit on the second side of the host vehicle in response to determining that the distance between the host vehicle and the second-side reported line is increasing at a greater rate than the distance between the host vehicle and the first-side reported line.

16. The method of claim 11, wherein detecting the highway exit on the second side of the host vehicle based at least in part on the analysis of the plurality of reported lines includes:
identifying a location of a target vehicle operating on the roadway surface based on radar data received by the electronic controller from at least one radar sensor;
determining a first angle indicative of trajectory of the target vehicle;
determining a second angle indicative of the second-side reported line; and
detecting the highway exit on the second side of the host vehicle in response to determining that a difference between the first angle and the second angle exceeds a defined tolerance threshold.

17. The method of claim 16, wherein the first angle is indicative of an angle of the trajectory of the target vehicle relative to a current trajectory of the host vehicle, and wherein the second angle is indicative of an angle of the second-side reported line relative to the current trajectory of the host vehicle.

18. The method of claim 11, wherein detecting the highway exit on the second side of the host vehicle based at least in part on the analysis of the plurality of reported lines includes:
identifying a location of a target vehicle operating on the roadway surface;
determining a first value indicative of a lateral distance between the target vehicle and the first-side reported line;
determining a second value indicative of a lateral distance between the target vehicle and the second-side reported line; and
detecting the highway exit on the second side of the host vehicle in response to determining that the second value is increasing at a greater rate than the first value.

19. The method of claim 11, wherein detecting the highway exit on the second side of the host vehicle based at least in part on the analysis of the plurality of reported lines includes:
determining, for each reported line of the plurality of reported lines, an angle of the reported line relative to a same reference line; and
detecting the highway exit on the second side of the host vehicle in response to determining that the angle of the second-side reported line deviates from the angle for each of the other reported lines relative to the same reference line.

20. The method of claim 11, further comprising applying a plurality of different exit detection methods based on the plurality of reported lines, and wherein detecting the highway exit on the second side of the host vehicle based at least in part on the analysis of the plurality of reported lines includes detecting the highway exit on the second side of the host vehicle based on output from each of the plurality of different exit detection methods.
